(19) United States
(12) Patent Application Publication
(10) Pub. No.: US 2009/0012853 A1
(43) Pub. Date: Jan. 8, 2009

(54) INFERRING LEGITIMACY OF ADVERTISEMENT CALLS

(75) Inventors: Michiel Nolet, New York, NY (US); John H. Dalto, New York, NY (US)

Correspondence Address: BRINKS HOFER GILSON & LIONE / YAHOO! OVERTURE, P.O. BOX 10395, CHICAGO, IL, 60610, US

(73) Assignee: Right Media, Inc., New York, NY (US)

(21) Appl. No.: 11/772,979

(22) Filed: Jul. 3, 2007

(51) Int. Cl. G07G 1/14

(52) U.S. Cl. 705/14

(57) ABSTRACT

There are methods and apparatus, including computer program products, for receiving advertisement calls at a first computing system from a second computing system, the first computing system and a second computing system being in electronic communication through a network, each advertisement call being defined by one or more variable-value pairs; extracting data from the advertisement calls, the extracted data including at least two sets of variable/value pairs, the first set of variable/value pairs including variable/value pairs of a first variable type, and the second set of variable/value pairs including variable/value pairs of a second variable type; and performing one or more tests on the extracted data to infer a legitimacy of at least a first subset of the advertisement calls.

### BACKGROUND

This description relates to inferring legitimacy of advertisement calls.

The proliferation of Internet activity has generated tremendous growth for advertising on the Internet. Typically, advertisers (i.e., buyers of advertisement space) and online publishers (i.e., sellers of advertisement space) have agreements with one or more advertisement networks, which provide for serving an advertiser's banner or advertisement across multiple publishers, and concomitantly provide for each publisher access to a large number of advertisers. Advertisement networks (which may also manage payment and reporting) may also attempt to target certain Internet users with particular advertisements to increase the likelihood that the user will take an action with respect to the ad. From an advertiser's perspective, effective targeting is important for achieving a high return on investment (ROI).

Traditionally, there are three types of Internet advertising payment models, namely Cost per Impression (CPI), Cost per Click (CPC), and Cost per Action (CPA). In the CPI model, for a given advertisement creative, an advertiser pays per one thousand impressions of the advertisement creative. In the CPC model, an advertiser only pays when a viewer (also referred to in this description as a “consumer of an advertisement creative” or simply “consumer”) clicks on the advertisement creative. In the CPA model, an advertiser only pays when a conversion action takes place after a consumer has clicked on the advertisement creative. Examples of conversion actions include filling in a form, purchasing an item related to the advertisement creative, subscribing to a service related to the advertisement creative, and enrolling in a program related to the advertisement creative.

Generally, an advertiser that participates in an Internet advertising market has a budget associated with an advertisement creative that is allocated to a given time period, e.g., a day, a week, a month, or a quarter. Suppose, for example, an advertiser has a weekly budget of $1,000 for an advertisement creative (“car advertisement”) that is related to a soon-to-be-launched sports car, and the car advertisement is to be served in twenty advertisement spaces. Each click on (or thousand impressions of) the car advertisement on any one of those twenty advertisement spaces decreases the weekly budget by the amount the advertiser paid for the car advertisement until the weekly budget reaches zero. At that time, the serving of the car advertisement is suspended for all twenty of the advertisement spaces for the remainder of the week. The serving of the advertisement may be resumed in the next time period, if appropriate. The amount (or some fraction thereof) paid by the advertiser for each click on the car advertisement that is served in a specific one of the twenty advertisement spaces is paid to the publisher of that advertisement space.

The Internet advertising market is subject to abuse in a number of ways. For example, one advertiser (“advertiser A”) or its proxy (human or bot) may intentionally and repeatedly click on an advertisement creative of a competitor (“advertiser B”) to deplete advertiser B's budget early in a given time period so that advertiser A has less competition in the serving of its advertisement creatives. To boost its advertisement revenue, a publisher may engage in unsavory techniques to attract a high volume of traffic to its web sites and/or provide content in a layout that causes web site visitors to inadvertently click on an advertisement creative displayed in an advertisement space of that site.

### SUMMARY

In one aspect, the invention features a computer-implemented method that includes receiving advertisement calls at a first computing system from a second computing system, the first computing system and a second computing system being in electronic communication through a network, each advertisement call being defined by one or more variable-value pairs; extracting data from the advertisement calls, the extracted data including at least two sets of variable/value pairs, the first set of variable/value pairs including variable/value pairs of a first variable type, and the second set of variable/value pairs including variable/value pairs of a second variable type; and performing one or more tests on the extracted data to infer a legitimacy of at least a first subset of the advertisement calls.

Implementations of the invention may include one or more of the following.

The first set of variable/value pairs may consist of variable/value pairs of the first variable type. The second set of variable/value pairs may consist of variable/value pairs of the second variable type.

The advertisement calls may be received from a first user agent of the second computing system, a second user agent of the second computing system, and/or a user agent of a third computing system. The user agents may be operable by a human user and/or a robot.

The first variable type may be an impression frequency and the second variable type may be an impression recency. The method of performing one or more tests on the extracted data may include determining a distribution of impressions over impression frequency and impression recency. The method may further include taking an action based on the determined distribution of impressions over impression frequency and impression recency. Taking an action may include flagging at least the first subset of the advertisement calls as being associated with fraudulent activity on an advertisement exchange or an advertisement network if the distribution of impressions over impression frequency and impression recency is determined to satisfy one or more conditions. Taking an action may include flagging at least the first subset of the advertisement calls as being associated with fraudulent activity on an advertisement exchange or an advertisement network if the distribution of impressions over impression frequency and impression recency is determined to be skewed toward one extremum of a distribution spectrum. Taking an action may include identifying a slice of inventory associated with the first subset of the advertisement calls as being associated with fraudulent activity on an advertisement exchange or an advertisement network based on the determined distribution; and suspending the identified slice of inventory from being transacted on the advertisement exchange or the advertisement network. Suspending the identified slice of inventory may include suspending non-cost-per-action-based items of inventory within the identified slice of inventory and/or deactivating the identified slice of inventory.

The first variable type may be a number of impressions, and a second variable type may be a number of clicks. The method may further include calculating click rates for a slice of inventory associated with the first subset of the advertisement calls based on the values of the first set of variable/value pairs and the values of the second set of variable/value pairs. The extracted data may further include a third set of variable/value pairs including variable/value pairs of a third variable type.

The third variable type may include an impression frequency, and the method of performing one or more tests on the extracted data may include performing an autocorrelation of variables test to determine whether there is a correlation between clicks rates and impression frequency.

The third variable type may include an impression recency, and the method of performing one or more tests on the extracted data may include performing an autocorrelation of variables test to determine whether there is a correlation between clicks rates and impression recency.

The third variable type may include a uniform resource locator (URL) frequency, and the method of performing one or more tests on the extracted data may include performing an autocorrelation of variables test to determine whether there is a correlation between clicks rates and URL frequency.

The third variable type may include an advertisement type, and a value assigned to the advertisement type may include one of the following: a value indicative of a Flash-type advertisement and a value indicative of a GIF-type advertisement.

The method of performing one or more tests on the extracted data may include taking an action if at least two of the following conditions are satisfied: (a) a number of impressions is greater than a predefined threshold, (b) click rate associated with Flash-type advertisements is zero; and (c) click rate associated with GIF-type advertisements is zero. Taking an action may include flagging at least the first subset of the advertisement calls as being associated with suspicious activity on an advertisement exchange or an advertisement network. Taking an action may include identifying the slice of inventory as being associated with suspicious activity on an advertisement exchange or an advertisement network.

The method of performing one or more tests on the extracted data may include performing an autocorrelation of variables tests to determine a degree of correlation between clicks rates and one or more of the following: impression frequency, impression recency, and uniform resource locator frequency; and taking an action based on one or more of the determined degrees of correlation. Taking an action may include flagging at least the first subset of the advertisement calls as being associated with suspicious activity on an advertisement exchange or an advertisement network if one or more of the determined degrees of correlation satisfies one or more conditions. Taking an action may include identifying a slice of inventory associated with the first subset of the advertisement calls as being associated with suspicious activity on an advertisement exchange or an advertisement network based on one or more of the determined degrees of correlation.

The method of performing one or more tests on the extracted data may include performing a conditional probabilities test to determine whether a slice of inventory is performing at an extremum of a spectrum with respect to conversions.

The method of performing one or more tests on the extracted data may include performing an autocorrelation of variables tests to determine a degree of correlation between clicks rates and one or more of the following: impression frequency, impression recency, and uniform resource locator frequency; performing a conditional probabilities test to determine whether a slice of inventory is performing at an extremum of a spectrum with respect to conversions; and performing an advertisement type test in which click rates associated with GIF-type advertisements and Flash-type advertisements are examined. The method may further include flagging at least the first subset of the advertisement calls as being associated with suspicious activity on an advertisement exchange or an advertisement network based on the results of any one of the tests. The method may further include flagging at least the first subset of the advertisement calls as being associated with fraudulent activity on the advertisement exchange or the advertisement network based on the results of at least two of the tests. The method may further include suspending a slice of inventory associated with the first subset of the advertisement calls from being transacted on the advertisement exchange or the advertisement network if the first set of advertisement calls is flagged as being associated with fraudulent activity on the advertisement exchange or the advertisement network. The method may further include suspending a slice of inventory associated with the first subset of the advertisement calls from being transacted on the advertisement exchange or the advertisement network if at least two of the tests that are performed indicate that the first set of advertisement calls is associated with fraudulent activity on the advertisement exchange or the advertisement network. The method may further include suspending non-cost-per-action-based items of inventory within a slice of inventory associated with the first subset of the advertisement calls from being transacted on the advertisement exchange or the advertisement network if at least two of the tests that are performed indicate that the first set of advertisement calls is associated with fraudulent activity on the advertisement exchange or the advertisement network.

In another aspect, the invention features a computer-implemented method that includes receiving advertisement calls for a slice of inventory on an advertisement exchange or an advertisement network, the advertisement call being received at a first computing system from a second computing system, the first computing system and a second computing system being in electronic communication through a network, each advertisement call being defined by one or more variable-value pairs; extracting data from the advertisement calls, the extracted data including at least two sets of variable/value pairs, the first set of variable/value pairs including variable/value pairs of a first variable type, and the second set of variable/value pairs including variable/value pairs of a second variable type; performing one or more tests on the extracted data to infer a legitimacy of at least a first subset of the advertisement calls; identifying non-cost-per-action-based items of inventory within the slice that are associated with the first subset of the advertisement calls; and based on the results of performing the one or more tests, suspending the identified non-cost-per-action-based items of inventory from being transacted on the advertisement exchange or an advertisement network.

Other general aspects include other combinations of the aspects and features described above and other aspects and features expressed as methods, apparatus, systems, computer program products, and in other ways

The details of one or more examples are set forth in the accompanying drawings and the description below. Further features, aspects, and advantages of the invention will become apparent from the description, the drawings, and the claims.

### DESCRIPTION OF DRAWINGS

FIG. 1 shows a block diagram of an open advertisement exchange environment.

FIG. 2 shows a URL tester module.

FIG. 3 shows a test node of a URL tester module.

### DETAILED DESCRIPTION

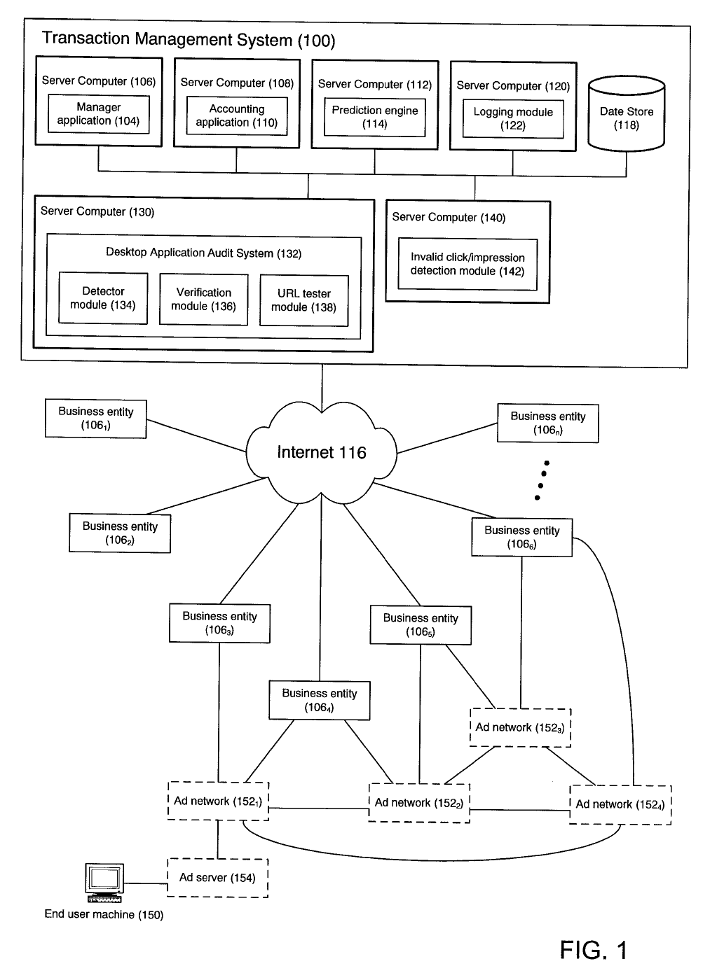

FIG. 1 shows a transaction management system 100 that is implemented as a multi-server system. The transaction management system 100 includes a server computer 102 that runs a manager application 104 to facilitate commercial transactions between business entities 106_{1 . . . n}, a server computer 108 that runs a computer program application (“accounting application” 110) to track and manage accounting activity associated with the commercial transactions, and a server computer 112 that runs a computer program application (“prediction engine” 114) to generate one or more predictive metrics for use by the manager application 104 in facilitating a commercial transaction.

Although the transaction management system 100 of FIG. 1 is described in the context of an open advertisement (“ad”) exchange that connects business entities through the Internet 116, the techniques implemented by the transaction management system 100 are also applicable in non-advertisement-related contexts and non-open-exchange contexts. Further, although depicted as separate server computers, in some implementations, one or more of the applications run on a single server computer server computers, and additional/different applications may also be included in the transaction management system 100.

To participate on the ad exchange, each business entity 106_{1 . . . n} registers with the transaction management system 100. Details of the types of information that a business entity 106_{1 . . . n} may be requested or required to provide to the transaction management system 100 during the registration process can be found in U.S. patent application Ser. No. 11/669,690, entitled “Open Media Exchange Platforms,” filed on Jan. 31, 2007, the contents of which are hereby incorporated by reference in its entirety. The information provided by the business entities may be stored in a data store 118 (e.g., a database) coupled to the transaction management system 100 or accessible by the transaction management system 100 via a network (e.g., the Internet 116, a local area network, or a wide area network).

Once registered, the role of a business entity 106_{1 . . . n} on the ad exchange is a function of the type of inventory the business entity manages for a given transaction. For example, if a business entity is managing an ad creative for a transaction, the role of the business entity is that of an “advertiser”; if a business entity is managing an ad space for a transaction, the business entity adopts the role of a “publisher.” A business entity may be a company that directly manages its own creatives/spaces on the ad exchange, or a company that manages ad creatives and/or ad spaces on behalf of one or more other companies and/or ad networks (e.g., ad network 152₁ and ad network 152₂) that do not operate on the ad exchange.

The transaction management system 100 may be implemented to enable a business entity to segment its ad creative inventory, e.g., by campaign or by advertiser. In the examples to follow, each item of ad creative inventory that is available for transacting on the ad exchange is associated with an identifier (advertiser ID) for an advertiser (e.g., Nike, Inc.), an identifier (campaign ID) for a campaign (e.g., “Just do it”), and an identifier (creative ID) for a creative (e.g., “Michael Jordan at full extension dunking over the slogan”). The combination of the advertiser, campaign, and creative identifiers (collectively referred to as the “advertiser-campaign-creative identifier”) enables both the transaction management system 100 and the business entity that is managing the ad creative to identify the particular ad creative that is being made available on the ad exchange.

The transaction management system 100 may also be implemented to enable a business entity to segment its ad space inventory, e.g., by section, by IP address, or by publisher. In the examples to follow, each item of ad space inventory that is available for transacting on the ad exchange is associated with an identifier (publisher ID) for a publisher (e.g., Yahoo! Inc.), an identifier (site ID) for a site (e.g., Yahoo!® Mail), and an identifier (section ID) for a section (e.g., Homepage) in which the ad space is located. The combination of the publisher, site, and section identifiers (collectively referred to as the “publisher-site-section identifier”) enables both the transaction management system 100 and the business entity that is managing the ad space to identify the particular section in which the ad space that is being made available on the ad exchange is located.

Each commercial transaction on the ad exchange is triggered by a receipt of an ad call for a section that is managed by a business entity. The transaction management system 100 includes a server computer 120 that runs a logging module 122 that logs at least the following information for each ad call that is received by the ad exchange: (1) a time stamp indicative of the time the ad call is received by the ad exchange; (2) publisher-site-section identifier combination that identifies the specific section associated with the ad call; (3) a referring URL; (4) an IP address associated with the referring URL, if available; (4) a page URL; (5) a web browser type; and (6) cookie information that provides some historical data related to a consumer's actions with respect to ad creatives, if available. In some implementations, the logging module 122 stores the logged information in the data store 118 by publisher-site-section identifier.

Details regarding the techniques that may be implemented by the transaction management system 100 for selecting an ad creative to be served responsive to an ad call received by the ad exchange, and for facilitating the business entities 106_{1 . . . n} managing the section and the selected ad creative in executing the commercial transaction itself can also be found in U.S. patent application Ser. No. 11/669,690, entitled “Open Media Exchange Platforms,” filed on Jan. 31, 2007, the contents of which are hereby incorporated by reference in its entirety.

### Desktop Application Audit System

We now describe one example scenario in which an ad call for inventory that is managed by a business entity 106_{1 . . . n} occurs. Referring to FIG. 1, an end user machine 150 includes web user agents that are operable by a human user or robot. Examples of web user agents include web browsers (e.g., Windows® Internet Explorer® and Apple® Safari™) and web-enabled desktop applications (e.g., AOL® Instant Messenger™, WeatherBug®, Splinter Cell® Chaos Theory™, Searchingbooth, and DriveCleaner).

A web user agent may be operable to send an ad call to an ad server 154 at periodic intervals (e.g., every 5 minutes). In one example, a web-enabled desktop application includes an embedded web browser that makes the ad call to the ad server 124. In another example, a web-enabled desktop application launches a web browser directed to a site at a particular page URL (e.g., “www.freepopups.com”), which makes the ad call to the ad server 154. The ad server 154 may be operable to redirect the ad call to the ad network 152₁, which itself may redirect the ad call to other ad networks (e.g., ad network 152₂ and ad network 152₄) and/or sections that are managed by business entities (e.g., business entity 106₃ and business entity 106₄). Consequently, the ad call that originated from a web-enabled desktop application at the end user machine 150 may enter the ad exchange through an innumerable number of sections, including sections that are managed by business entity 106₃, business entity 106₄, business entity 106₅, and business entity 106₆.

Given the number of redirects that may occur for any given ad call, it is sometimes/often the case that the business entity managing the section that serves as the entry point into the ad exchange for the ad call, the business entity managing the ad creative that is served responsive to the ad call, and the transaction management system 100 have no knowledge (or limited knowledge) of the identity and/or type of web-enabled desktop application that originated the ad call. As a result, the company (e.g., Acme, Inc.) whose ad creative is served in response to the ad call may find that it is paying for its ad creatives to be served to both legitimate and illegitimate types of web-enabled desktop applications with no way of distinguishing between the two.

To address this issue, the transaction management system 100 includes a server computer 130 that runs a desktop application audit system 132. In one implementation, the desktop application audit system 132 has three modules; the functionality of each is described below.

A first module (“detector module” 134) of the desktop application audit system 132 is operable to identify those instances in which ad calls received by the ad exchange for a section originate from a web-enabled desktop application. At periodic intervals (e.g., every 60 minutes), the detector module 134 examines the URLs (“URL under test”) that have been stored in the most recent 60 minute time interval for each network-publisher-site-section identifier. The URLs may be referring URL and/or page URLs. In one implementation of the detector module 134, the URL examination involves performing a lookup operation of a database of URLs (“db URLs”) to identify a match. If a URL under test matches a db URL that has been previously-identified by the transaction management system 100 as being associated with a legitimate type of web-enabled desktop application, no further action is taken by the detector module 134. If a URL under test matches a db URL that has been previously-identified by the transaction management system 100 as being associated with an illegitimate type of web-enabled desktop application, the detector module 134 takes an action to ban the section associated with the network-publisher-site-section identifier from participating in any transactions on the ad exchange. If the URL under test does not match a db URL, the detector module 134 examines the distribution(s) of IP addresses, ad call frequency and/or web browser type for the URL under test during the most recent 60 minute time interval to determine whether patterns indicative of ad calls initiated by web-enabled desktop applications exist. If the examination reveals a certain level of randomness in the characteristics of the ad calls associated with the particular network-publisher-site-section identifier, no further action is taken by the detector module 134. If, on the other hand, the detector module 134 is able to discern a pattern (or patterns) in the characteristics of the ad calls, the detector module 134 adds the URL under test to a list of unverified URLs that require further analysis. In those instances in which multiple URLs share the same domain, the first module groups the URLs in the list of unverified URLs by domain.

The desktop application audit system 132 includes a second module (“verification module” 136) that is in electronic communication with one or more third party data sources (e.g., WHOIS, SiteAdvisor, and Stopbadware.org). The verification module 136 provides information in a graphical user interface that enables a human auditor to adopt a holistic approach in examining each URL (or group of URLs) in the list of unverified URLs. In a simple example, suppose a third party data source reveals that the IP address of an unverified URL is an IP address of a server that has been identified by a third party data source as associated with an illegitimate type of web-enabled desktop application. In another example, suppose a third party data source reveals that the domain name of the unverified URL (e.g., AAAspyware.com) is one character off from a URL (e.g., AAAAspyware.com) that is known to be associated with an illegitimate type of web-enabled desktop application. In both of these example scenarios, the human auditor may, with a high level of confidence, mark the URL identified by the network-publisher-site-section identifier as being associated with an illegitimate type of desktop application. After the marking, the verification module 136 takes an action to ban all sections that have the URL from participating in any transactions on the ad exchange. The verification module 136 may also move the URL from the list of unverified URLs to the list of URLs that are known to be associated with illegitimate types of desktop applications.

As an alternative to relying on human judgment, the verification module 136 may be implemented to examine an unverified URL and automatically determine whether the section identified by the network-publisher-site-section identifier should be marked as associated with an illegitimate type of web-enabled desktop application without human judgment.

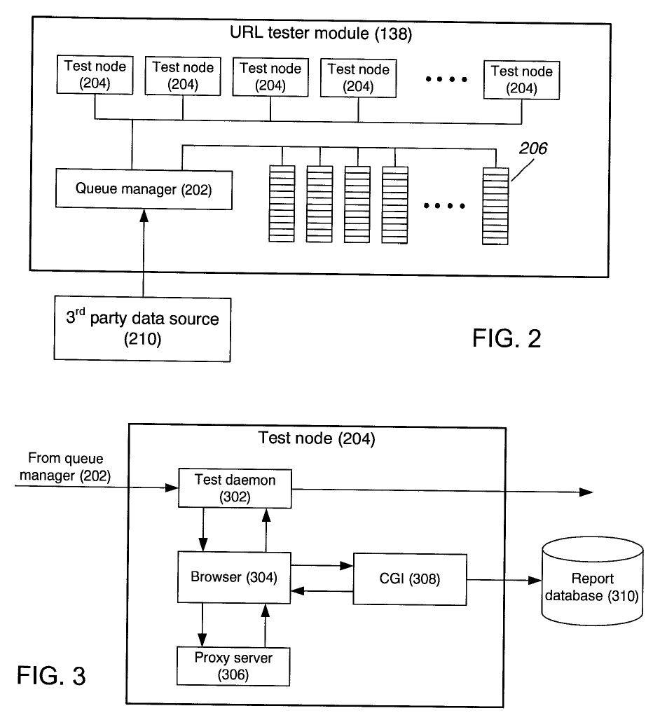

A third module (“URL tester module” 138) of the desktop application audit system 130 is operable to subject URLs that are known to be associated with illegitimate types of web-enabled desktop applications to a test suite in order to identify those URLs that result in ad calls to sections on the ad exchange. Referring also to FIG. 2, in one implementation, the URL tester module 138 includes a queue manager 202 and a set of test nodes 204. The queue manager is operable to receive candidate URLs from third party data sources 210 (e.g., McAfee, Inc. and Symantec Corp.) and/or the detector module 134, and place each candidate URL into one of possibly several queues 206 for inspection (or re-inspection) by the URL tester module 138.

Each queue 206 has several attributes. For example, each queue 206 has a priority, which, in one practice, is selected from two different levels. Each queue 206 also has a loop value, which controls what happens when the last candidate URL in the queue is reached. In some cases, the loop value indicates that when the last candidate URL in the queue is reached, the queue manager is to loop back to its first candidate URL. Such a queue 206 will therefore never end. In other cases, each candidate URL in a queue is tested a pre-determined number of times, after which that candidate URL is deleted from the queue 206.

In some practices, candidates URLs are associated with historical data indicative of the inspection history of that candidate URL. For example, the historical data may indicate that despite repeated inspections, the candidate URL has consistently been found to result in an ad call to a section on the ad exchange. Because of its previous bad behavior, it may be preferable to re-inspect such a candidate URL more frequently. Or, the historical data may indicate that in previous inspections, a particular candidate URL has not been found to result in repeated/multiple ad calls to sections on the ad exchange. Because of this, it may be preferable to re-inspect such a candidate URL less frequently.

The historical data associated with a candidate URL can then be used to calculate a priority value for that candidate URL and to periodically update that priority value in response to changes in the historical data. This dynamically adjusted priority value can then be used as a basis for deciding what order to inspect the candidate URL in a particular queue 206.

In systems that use priority values, it is no longer necessary to maintain several queues 206. This is because the priority values of the candidate URLs within a single queue 206 effectively create as many virtual queues within that single queue as there are priority values.

The queue manager 202 carries out two operations: adding a candidate URL to a queue 206 and identifying the first available candidate URL from a specified queue 206 to be subjected to a test suite by a test node 204 of the URL tester module 138. The number of test nodes 204 that exist within a URL tester module 138 is flexible. In some installations, there may be as few as ten test nodes 204 running in parallel. In other installations, there are as many as five-hundred test nodes 204 running in parallel. However, the optimal number of test nodes 204 depends primarily on expected processing load and on available hardware capacity.

Referring now to FIG. 3, each test node 204 includes a test daemon 302 for launching a fully-functional browser 304 and providing that browser 304 with a candidate URL. A test node's browser 304 obtains its initial HTML code from a gateway specified by a queue from which the candidate URL was retrieved (i.e., the “originating” queue). In addition, the originating queue 206 can specify an external proxy, which enables that information from the gateway to be requested indirectly.

The test node 204 further includes a proxy-server 306 that filters requests from the browser 304 and processes any incoming information. A CGI (“Common Gateway Interface”) 308 provides communication between the browser 304 and a report database 310, in which are stored results of the test suite.

By loading the candidate URL into a fully-functional browser 304 in communication with a proxy server 306, the test node 204 can capture any hops through the Internet 116 that result from the loading of that candidate URL. In addition, the test node 204 has the opportunity to capture, record, and analyze each byte of data that passes to or from the browser 304.

The constituents of the test node 204 cooperate to execute a test suite. Some tests within the test suite are performed by the proxy server 306 alone, whereas other tests can only be performed by the browser 304. Certain other tests, for example examination of a tag list, can be carried out only when information from preceding tests has been collected. Such tests are carried out by the test daemon 302.

The test suite begins with the test daemon 302 receiving, from the queue manager 202, a command that identifies the candidate URL to be tested, together with the particular queue 206 on which that candidate URL can be found, and the appropriate gateway. The test daemon 302 provides this information to the proxy server 306. The proxy server 306 then resets its internal parameters and initiates corresponding records in the report database 310. It then waits for the test suite to begin.

Meanwhile, the test daemon 302 launches a browser 304 and provides it with a candidate URL. Once the browser 304 launches, the test daemon 302 goes to sleep. It awakens again upon a normal termination of the test suite, for example by receiving a “window.close” command from the CGI 308 In some practices, the test daemon 302 maintains a timeout counter, in which case, upon occurrence of a timeout, the test daemon 302 awakens to send a kill signal to the browser 304.

The proxy-server 306 functions as an interface between the browser 304 and the Internet 116. When the testing of a candidate URL results in an ad creative being served by the ad exchange, this ad creative must pass through the proxy server 306 before it is displayed in the browser 304. This allows the proxy server 306 to determine that the candidate URL under test made an ad call, either directly or indirectly, to a section on the ad exchange, and provides information associated with the served ad creative that is sufficient to identify the specific section on the ad exchange to which the ad call was made. The candidate URL tester module 138 takes actions to ban the identified section from transacting on the ad exchange.

### Invalid Click/Impression Detection Module

As previously-discussed, each commercial transaction on the ad exchange is triggered by a receipt of an ad call for a section that is managed by a business entity, and the logging module 122 logs, for each ad call, cookie information that provides some historical data related to a consumer's actions with respect to ad creatives.

The cookie information that is logged per ad call may be used to generate data sets for each section on the ad exchange. In one implementation, the transaction management system 100 generates and maintains a section-specific data set that includes empirical data relating to consumer actions for a given time interval (e.g., four days worth of historical data). The empirical data includes impression frequency (imp_freq), impression recency (imp_rec), and vURL frequency (vURL_freq), where:
1. Impression frequency (imp_freq): This is a bucketed value between 0 and 13, and 255, where imp_freq_bucket [0, 1, 2, 3, 4, 5, . . . 11, 12, 13, 255] represents {never seen advertisement before, 1 previous instance of advertisement being displayed, 2 previous instances of advertisement being displayed, 3 previous instances of advertisement being displayed, 4 previous instances of advertisement being displayed, 5 or 6 previous instances of advertisement being displayed, 7 or 8 previous instances of advertisement being displayed, 9 or 10 previous instances of advertisement being displayed, 11 to 15 previous instances of advertisement being displayed, 16 to 20 previous instances of advertisement being displayed, 21 to 25 previous instances of advertisement being displayed, 26 to 50 previous instances of advertisement being displayed, 51 to 100 previous instances of advertisement being displayed, cookies disabled at consumer's browser}. For each imp_freq bucket, the transaction management system keeps track of the number of impressions that are served, the number of clicks that occur in relation to the served impressions, and subsequently computes the click rate for advertisements given the frequency with which the impressions are being served to unique consumers. Suppose, for example, that the transaction management system records 2145891 impressions and 7434 clicks with respect to advertisements that are being viewed for the first time by consumers (i.e., imp_freq bucket [0]) and records 443267 impressions and 1862 clicks with respect to advertisements that are being viewed for the second time by consumers (i.e., imp_freq bucket [1]). The transaction management system calculates a click rate of 7434 clicks/2145891 impressions=0.003464295 for impressions that are being viewed for the first time by consumers and a click rate of 1862 clicks/443267 impressions=0.004200629 for impressions that are being viewed for the second time by consumers.
2. Impression recency (imp_rec): This is a bucketed value between 0 and 18, and 255, where imp_rec_buckets [0, 1, 2, 3, 4, 5, . . . 16, 17, 18, 255] represent {0-15 secs, 16-30 secs, 31-60 secs, 1 min-1½ mins, 1½mins-2 mins, 2-3 mins, 3-5 mins, 5-10 mins, 10-15 mins, 15-30 mins, 30 mins-1 hr, 1-6 hours, 6-12 hours, 12-24 hours, 1-2 days, 2-7 days, 7-14 days, 14-30 days, cookies disabled at consumer's browser}. For each imp_rec bucket, the transaction management system keeps track of the number of impressions that are served, the number of clicks that occur in relation to the served impressions, and subsequently computes the click rate for advertisements given the recency with which the impressions are being served to unique consumers. Suppose, for example, that the transaction management system records 48123 impressions and 106 clicks with respect to advertisements that are viewed by consumers within the most recent 15-second time period (i.e., imp_rec bucket [0]) and records 9075 impressions and 20 clicks with respect to advertisements that are being viewed by consumers within the next more recent 15-second time period (i.e., imp_rec bucket [1]). The transaction management system calculates a click rate of 106 clicks/48123 impressions=0.002202688 for impressions that are being viewed within the most recent 15-second time period and a click rate of 20 clicks/9075 impressions=0.002203856 for impressions that are being viewed within the next most recent 15-second time period.
3. vURL frequency (vurl_freq): This is a bucketed value between 0 and 123, and 255. Each bucketed value represents the number of times a consumer's browser has loaded a given validated URL (e.g., http://wwwjustanexample.com).

In some implementations, the transaction management system 100 includes a server computer 140 that includes an invalid click/impression detection module 142. The invalid click/impression detection module 142 is operable to run a single test or a combination of tests on the section-specific data sets at periodic intervals to determine whether inappropriate or fraudulent behavior has occurred on the ad exchange for a given section, and if so, identify an action to be taken. In the examples below, four tests that may be run by the invalid click/impression detection module 142 are described in the context of determining whether fraudulent behavior has occurred with respect to a section under test.

### Single Test

In this portion of the description, a single test for use in determining whether inappropriate or fraudulent behavior has occurred on the ad exchange is described.

In general, the distribution of impressions over imp_freq and imp_rec for any given consumer is expected to take on a relatively-predictable shape when graphed. There are 270 (i.e., 18 bucketed values for imp_freq×15 bucketed values for imp_rec) unique combinations of [imp_freq, imp_rec] values that the invalid click/impression detection module 142 expects to occur for any given section. When a section is targeted by a person, automated script, or computer program that is attempting to imitate a legitimate consumer's actions with respect to the advertisements served in the ad spaces of the section, the [imp_freq, imp_rec] values typically take the form of [imp_freq=0, imp_rec=255] and/or [imp_freq=255, imp_rec=255].

The invalid click/impression detection module may be implemented to run an impression frequency/recency distribution test for a given section under test that involves obtaining a sample of [imp_freq, imp_rec] values for a period of time, T(n), and examining the obtained values to determine whether the number of [imp_freq=0, imp_rec=255] values and/or [imp_freq=255, imp_rec=255] values exceeds one or more predefined thresholds. A positive result triggers the invalid click/impression detection module 142 to flag the behavior on the ad exchange with respect to the section under test as “fraudulent” and suspend the section under test until the flag is cleared.

In some implementations, the suspension has the effect of removing all advertising spaces associated with the section under test from being made available on the ad exchange for acquisition. In other implementations, the suspension has the effect of enabling only those advertising spaces of the section under test that are subject to the CPA model to be acquired on the ad exchange for a period of time, T(s). Subsequently, the invalid click/impression detection module 142 examines the conversion rate (i.e., the percentage of consumers that perform an advertiser-defined post-click action) on the advertisements served in the advertisement spaces of the section under test during the time period, T(s). If the conversion rate is above a predefined threshold, the invalid click/impression detection module 142 identifies the previously-flagged fraudulent behavior as a false hit, and clears the flag. However, in those instances in which the conversion rate is below the predefined threshold, the invalid click/impression detection module 142 maintains the suspension of the section under test until the flag is cleared by the transaction management system 100, e.g., in response to an explicit instruction received from an individual or entity authorized to investigate inappropriate or fraudulent behavior on the ad exchange.

### Combination of Tests

In this portion of the description, a combination of tests for use in determining whether inappropriate or fraudulent behavior has occurred on the ad exchange is described.

In general, a legitimate consumer's behavior with respect to an advertisement can be characterized as follows: (1) the more times the consumer sees an advertisement, the less likely the consumer will click on the advertisement; (2) the more recently the consumer sees an advertisement, the less likely the consumer will click on the advertisement; and (3) the more times the consumer's browser loads a given vURL, the less likely the consumer will click on any advertisement displayed in the web page. Accordingly, when a graph of click rates vs. imp_freq/imp_rec/vURL for any given section is plotted, the expected result is a decaying exponential curve.

The invalid click/impression detection module 142 may leverage this knowledge of legitimate consumer behavior to determine whether a given section under test has been the target of a person, automated script, or computer program that is attempting to imitate a legitimate consumer's actions. In some implementations, the invalid click/impression detection module 142 runs a series of autocorrelation of variables tests to determine whether there is a correlation between the empirical data of click rates vs. imp_freq/imp_rec/vURL obtained for a section under test over a given time period and a decaying exponential function. A weak correlation or no correlation result serves as an indicator of suspicious behavior on the ad exchange with respect to the section under test. Suppose, for example, the invalid click/impression detection module 142 is implemented to run an autocorrelation of variables tests for each of click rates vs. imp_freq, click rates vs. imp_rec, and click rates vs. vURL at 24-hour intervals for each section. During each test, the invalid click/impression detection module 142 obtains four days worth of historical empirical data for the section under test and takes an autocorrelation of the series data consisting of click rates vs. imp_freq/imp_rec/vURL with a decaying exponential function. If the result of any one of the three autocorrelation of variables tests reveals a weak correlation or no correlation between the historical empirical data for the section under test and the decaying exponential function, the invalid click/impression detection module 142 flags the behavior on the ad exchange with respect to the section under test as “suspicious”.

For each section under test that has been flagged as a target of “suspicious” behavior on the ad exchange, the invalid click/impression detection module 142 runs a conditional probabilities test to determine whether the “suspicious” behavior rises to the level of “fraudulent” behavior. In general, it is relatively difficult for a person, automated script, or computer program to imitate a legitimate consumer's actions with respect to conversions. For example, it may be easy to generate a script that automatically clicks on all advertisements on a web page, but it is more complex to generate a script that enters a sequence of requisite information (e.g., a fillable form) that serves as the conversion action specified by the advertiser. Sections under test that are observed to have performed extremely poorly with regards to conversion actions are likely to have been inappropriately targeted by a person, automated script, or computer program.

In some implementations, the invalid click/impression detection module 142 runs a conditional probabilities test that involves computing the probability of observing a fixed number of conversions on a section under test given a number of impressions and clicks. For example, if a section under test has K conversions, I impressions, and C clicks, the invalid click/impression module may be implemented to compute the following:

Prob[(#Convs<K)|(#Imps>I and #Clicks>C)]

To obtain the value of (#Imps>I and #Clicks>C), the invalid click/impression detection module 142 scans four days worth of historical empirical data across the ad exchange to identify the number of sections N with both a number of impressions that is greater than I (of the section under test) and a number of clicks that is greater than C (of the section under test). Of these N sections, the invalid click/impression detection module 142 identifies the number of sections M that have fewer than K conversions. If the probability of M, given N is high (e.g., greater than 50%), this serves as an indicator to the invalid click/impression detection module 142 that the section under test is performing on average with respect to conversions and that the flagging of the section under test as being a target of “suspicious” behavior on the ad exchange was likely premature.

In those instances in which the probability of M, given N is low (e.g., less than 5%), which indicates that the section under test is either performing very poorly or very well with respect to conversions, the invalid click/impression detection module 142 runs one additional test that examines the performance of the section under test by advertisement type to determine whether the behavior on the ad exchange with respect to the section under test rises to the level of “fraudulent.” In some implementations, the invalid click/impression detection module 142 runs a Flash vs. GIF test that includes examining the click rates (e.g., over the most recent four-day time interval) associated with the Flash- and GIF-type advertisements that are served in the section under test, and suspending the section under test in those instances in which three conditions are met: (1) the click rates associated with the Flash-type advertisements is zero; (2) the click rates associated with the GIF-type advertisements is greater than zero; and (3) the number of impressions served within the section under test is greater than a predefined threshold (e.g., more than 5000 impressions). The suspension of the section under test may be maintained until the flag is cleared by the transaction management system 100, e.g., in response to an explicit instruction received from an individual or entity authorized to investigate suspicious behavior on the ad exchange. If one or more of the conditions are not met, the invalid click/impression detection module 142 deems the behavior on the ad exchange with respect to the section under test as “normal.”

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Although the techniques have been described herein in the context of a segment of inventory that is sliced by section, the techniques are also applicable to any subset of inventory that is sliced by publisher, site, section, URL, and/or any determining variable such as geography, frequency, etc.

Other embodiments are within the scope of the following claims. The following are examples for illustration only and not to limit the alternatives in any way. The techniques described herein can be performed in a different order and still achieve desirable results.

What is claimed is:

1. A computer-implemented method comprising:
receiving advertisement calls at a first computing system from a second computing system, the first computing system and a second computing system being in electronic communication through a network, each advertisement call being defined by one or more variable-value pairs;
extracting data from the advertisement calls, the extracted data including at least two sets of variable/value pairs, the first set of variable/value pairs including variable/value pairs of a first variable type, and the second set of variable/value pairs including variable/value pairs of a second variable type; and
performing one or more tests on the extracted data to infer a legitimacy of at least a first subset of the advertisement calls.

2. The method of claim 1, wherein the first set of variable/value pairs consists of variable/value pairs of the first variable type.

3. The method of claim 1, wherein the second set of variable/value pairs consists of variable/value pairs of the second variable type.

4. The method of claim 1, wherein at least the first subset of the advertisement calls are received from a first user agent of the second computing system.

5. The method of claim 4, wherein the first user agent is operable by a human user.

6. The method of claim 4, wherein the first user agent is operable by a robot.

7. The method of claim 4, wherein at least a second subset of the advertisement calls are received from a second user agent of the second computing system.

8. The method of claim 4, wherein at least a second subset of the advertisement calls are received from a user agent of a third computing system.

9. The method of claim 1, wherein the first variable type comprises an impression frequency and the second variable type comprises an impression recency.

10. The method of claim 1, wherein performing one or more tests on the extracted data comprises:
determining a distribution of impressions over impression frequency and impression recency.

11. The method of claim 10, further comprising:
taking an action based on the determined distribution of impressions over impression frequency and impression recency.

12. The method of claim 11, wherein taking an action comprises:
flagging at least the first subset of the advertisement calls as being associated with fraudulent activity on an advertisement exchange or an advertisement network if the distribution of impressions over impression frequency and impression recency is determined to satisfy one or more conditions.

13. The method of claim 11, wherein taking an action comprises:
flagging at least the first subset of the advertisement calls as being associated with fraudulent activity on an advertisement exchange or an advertisement network if the distribution of impressions over impression frequency and impression recency is determined to be skewed toward one extremum of a distribution spectrum.

14. The method of claim 11, wherein taking an action comprises:
identifying a slice of inventory associated with the first subset of the advertisement calls as being associated with fraudulent activity on an advertisement exchange or an advertisement network based on the determined distribution; and
suspending the identified slice of inventory from being transacted on the advertisement exchange or the advertisement network.

15. The method of claim 14, wherein suspending the identified slice of inventory comprises:
suspending non-cost-per-action-based items of inventory within the identified slice of inventory.

16. The method of claim 14, wherein suspending the identified slice of inventory comprises:
deactivating the identified slice of inventory.

17. The method of claim 1, wherein the first variable type comprises a number of impressions, and a second variable type comprises a number of clicks.

18. The method of claim 17, further comprising:
calculating click rates for a slice of inventory associated with the first subset of the advertisement calls based on the values of the first set of variable/value pairs and the values of the second set of variable/value pairs.

19. The method of claim 18, wherein the extracted data further comprises a third set of variable/value pairs including variable/value pairs of a third variable type.

20. The method of claim 19, wherein the third variable type comprises an impression frequency, and wherein performing one or more tests on the extracted data comprises:
performing an autocorrelation of variables test to determine whether there is a correlation between clicks rates and impression frequency.

21. The method of claim 19, wherein the third variable type comprises an impression recency, and wherein performing one or more tests on the extracted data comprises:
performing an autocorrelation of variables test to determine whether there is a correlation between clicks rates and impression recency.

22. The method of claim 19, wherein the third variable type comprises a uniform resource locator (URL) frequency, and wherein performing one or more tests on the extracted data comprises:
performing an autocorrelation of variables test to determine whether there is a correlation between clicks rates and URL frequency.

23. The method of claim 19, wherein the third variable type comprises an advertisement type, and wherein a value assigned to the advertisement type comprises one of the following: a value indicative of a Flash-type advertisement and a value indicative of a GIF-type advertisement.

24. The method of claim 1, wherein performing one or more tests on the extracted data comprises:
taking an action if at least two of the following conditions are satisfied: (a) a number of impressions is greater than a predefined threshold, (b) click rate associated with Flash-type advertisements is zero; and (c) click rate associated with GIF-type advertisements is zero.

25. The method of claim 24, wherein taking an action comprises:
flagging at least the first subset of the advertisement calls as being associated with suspicious activity on an advertisement exchange or an advertisement network.

26. The method of claim 24, wherein taking an action comprises:
identifying the slice of inventory as being associated with suspicious activity on an advertisement exchange or an advertisement network.

27. The method of claim 1, wherein performing one or more tests on the extracted data comprises:
performing an autocorrelation of variables tests to determine a degree of correlation between clicks rates and one or more of the following: impression frequency, impression recency, and uniform resource locator frequency; and
taking an action based on one or more of the determined degrees of correlation.

28. The method of claim 27, wherein taking an action comprises:
flagging at least the first subset of the advertisement calls as being associated with suspicious activity on an advertisement exchange or an advertisement network if one or more of the determined degrees of correlation satisfies one or more conditions.

29. The method of claim 27, wherein taking an action comprises:
identifying a slice of inventory associated with the first subset of the advertisement calls as being associated with suspicious activity on an advertisement exchange or an advertisement network based on one or more of the determined degrees of correlation.

30. The method of claim 1, wherein performing one or more tests on the extracted data comprises:
performing a conditional probabilities test to determine whether a slice of inventory is performing at an extremum of a spectrum with respect to conversions.

31. The method of claim 1, wherein performing one or more tests on the extracted data comprises:
performing an autocorrelation of variables tests to determine a degree of correlation between clicks rates and one or more of the following: impression frequency, impression recency, and uniform resource locator frequency;
performing a conditional probabilities test to determine whether a slice of inventory is performing at an extremum of a spectrum with respect to conversions; and
performing an advertisement type test in which click rates associated with GIF-type advertisements and Flash-type advertisements are examined.

32. The method of claim 31, further comprising:
flagging at least the first subset of the advertisement calls as being associated with suspicious activity on an advertisement exchange or an advertisement network based on the results of any one of the tests.

33. The method of claim 31, further comprising:
flagging at least the first subset of the advertisement calls as being associated with fraudulent activity on the advertisement exchange or the advertisement network based on the results of at least two of the tests.

34. The method of claim 31, further comprising:
suspending a slice of inventory associated with the first subset of the advertisement calls from being transacted on the advertisement exchange or the advertisement network if the first set of advertisement calls is flagged as being associated with fraudulent activity on the advertisement exchange or the advertisement network.

35. The method of claim 1, further comprising:
suspending a slice of inventory associated with the first subset of the advertisement calls from being transacted on the advertisement exchange or the advertisement network if at least two of the tests that are performed indicate that the first set of advertisement calls is associated with fraudulent activity on the advertisement exchange or the advertisement network.

36. The method of claim 1, further comprising:
suspending non-cost-per-action-based items of inventory within a slice of inventory associated with the first subset of the advertisement calls from being transacted on the advertisement exchange or the advertisement network if at least two of the tests that are performed indicate that the first set of advertisement calls is associated with fraudulent activity on the advertisement exchange or the advertisement network.

37. A machine-readable medium that stores executable instructions to cause a machine to:
receive advertisement calls at a first computing system from a second computing system, the first computing system and a second computing system being in electronic communication through a network, each advertisement call being defined by one or more variable-value pairs;
extract data from the advertisement calls, the extracted data including at least two sets of variable/value pairs, the first set of variable/value pairs including variable/value pairs of a first variable type, and the second set of variable/value pairs including variable/value pairs of a second variable type; and
perform one or more tests on the extracted data to infer a legitimacy of at least a first subset of the advertisement calls.

38. The machine-readable medium of claim 37, wherein instructions to cause the machine to perform one or more tests comprise instructions to:
determine a distribution of impressions over impression frequency and impression recency.

39. The machine-readable medium of claim 37, wherein instructions to cause the machine to perform one or more tests comprise instructions to:
perform an autocorrelation of variables test to determine whether there is a correlation between clicks rates and impression frequency.

40. The machine-readable medium of claim 37, wherein instructions to cause the machine to perform one or more tests comprise instructions to:
perform an autocorrelation of variables test to determine whether there is a correlation between clicks rates and impression recency.

41. The machine-readable medium of claim 37, wherein instructions to cause the machine to perform one or more tests comprise instructions to:
perform an autocorrelation of variables test to determine whether there is a correlation between clicks rates and URL frequency.

42. The machine-readable medium of claim 37, wherein instructions to cause the machine to perform one or more tests comprise instructions to:
perform a conditional probabilities test to determine whether a slice of inventory is performing at an extremum of a spectrum with respect to conversions.

43. The machine-readable medium of claim 37, further comprising instructions to cause the machine to:
based on results of the one or more tests, flagging at least the first subset of the advertisement calls as being associated with suspicious activity on an advertisement exchange or an advertisement network.

44. The machine-readable medium of claim 37, further comprising instructions to cause the machine to:
based on results of the one or more tests, identify a slice of inventory associated with the first subset of the advertisement calls as being associated with suspicious activity on an advertisement exchange or an advertisement network; and
suspend the identified slice of inventory from being transacted on the advertisement exchange or the advertisement network.

45. The machine-readable medium of claim 44, wherein instructions to suspend the identified slice of inventory comprise instructions to:
suspend non-cost-per-action-based items of inventory within the identified slice of inventory.

46. A computer-implemented method comprising:
receiving advertisement calls for a slice of inventory on an advertisement exchange or an advertisement network, the advertisement call being received at a first computing system from a second computing system, the first computing system and a second computing system being in electronic communication through a network, each advertisement call being defined by one or more variable-value pairs;
extracting data from the advertisement calls, the extracted data including at least two sets of variable/value pairs, the first set of variable/value pairs including variable/value pairs of a first variable type, and the second set of variable/value pairs including variable/value pairs of a second variable type;
performing one or more tests on the extracted data to infer a legitimacy of at least a first subset of the advertisement calls;
identifying non-cost-per-action-based items of inventory within the slice that are associated with the first subset of the advertisement calls; and
based on the results of performing the one or more tests, suspending the identified non-cost-per-action-based items of inventory from being transacted on the advertisement exchange or an advertisement network.

47. A machine-readable medium that stores executable instructions to cause a machine to:
receive advertisement calls for a slice of inventory on an advertisement exchange or an advertisement network, the advertisement call being received at a first computing system from a second computing system, the first computing system and a second computing system being in electronic communication through a network, each advertisement call being defined by one or more variable-value pairs;
extract data from the advertisement calls, the extracted data including at least two sets of variable/value pairs, the first set of variable/value pairs including variable/value pairs of a first variable type, and the second set of variable/value pairs including variable/value pairs of a second variable type;
perform one or more tests on the extracted data to infer a legitimacy of at least a first subset of the advertisement calls;
identify non-cost-per-action-based items of inventory within the slice that are associated with the first subset of the advertisement calls; and
based on the results of the performance of the one or more tests, suspend the identified non-cost-per-action-based items of inventory from being transacted on the advertisement exchange or an advertisement network.
